(19) United States
(12) Patent Application Publication
(10) Pub. No.: US 2025/0107487 A1
(43) Pub. Date: Apr. 3, 2025

(54) HYDRAULIC PRESSURE ESTIMATED BY OIL TEMPERATURE

(71) Applicant: Topcon Positioning Systems, Inc., Livermore, CA (US)

(72) Inventors: James SCHNAIDER, Martensville (CA); Matthew PETRYSHYN, Hague (CA)

(73) Assignee: Topcon Positioning Systems, Inc., Livermore, CA (US)

(21) Appl. No.: 18/479,240

(22) Filed: Oct. 2, 2023

(51) Int. Cl. A01D 41/127

(52) U.S. Cl. CPC A01D 41/1274; A01D 41/1271

(57) ABSTRACT

Systems, methods and machines are provided for determining a free-running pressure of a machine. The method can include receiving a measurement of a temperature of a hydraulic fluid within a hydraulic circuit of the machine, the hydraulic circuit including a hydraulic motor configured to pump the hydraulic fluid through the hydraulic circuit; receiving a measurement of a first pressure of the hydraulic fluid at a first point within the hydraulic circuit; and determining the free-running pressure of the hydraulic motor based on the temperature of the hydraulic fluid.

### BACKGROUND

The present disclosure relates generally to estimating hydraulic power, such as free-running hydraulic power, of a machine by measuring hydraulic fluid temperature at a location of the machine.

Hydraulic equipment, including agricultural equipment such as a sugarcane harvester, and including work vehicles, such as bulldozers and wheel loaders, include a hydraulic circuit that supplies hydraulic fluid to a power transmission device. For example, sugarcane harvesters use the hydraulic circuit to process harvested material with a hydraulically-driven chopper system and a hydraulically-driven trash extractor system, which are both within the hydraulic circuit.

Power measurement of various systems within the hydraulic circuit of the hydraulic equipment can be important for understanding the hydraulic equipment's performance and for data collection, such as agricultural data collection (e.g., generating yield maps to show spatial crop yield variability during use of the agricultural equipment).

The hydraulic circuit of the hydraulic equipment includes a pump, which pumps the hydraulic fluid through the hydraulic circuit to a hydraulic motor. The hydraulic motor power consumption is defined by the hydraulic fluid flow multiplied by hydraulic fluid pressure (with a motor efficiency factor, a constant value). Hydraulic fluid flow rate may be monitored by motor speed and pressure drop across the motor can be measured using hydraulic pressure transducers.

An amount of free-running (e.g. “zero-throughput power” or “idle load”) power is used to circulate hydraulic fluid through the hydraulic circuit when the hydraulic equipment is not being operated, such as when a sugarcane harvester is not processing any material. To quantify the power required to process the material (the amount of pressure above that of the free-running pressure level), it is beneficial to estimate the free-running pressure and/or power as conditions of the hydraulic power change and/or as environmental conditions change.

An example of the change in free-running power is shown in FIG. 1A. In this example, differential pressure across a chopper of a sugarcane harvester over time is presented as the green data. In the region to the left of FIG. 1A (˜<100), region A, the chopper is off, in the elevated region on the right hand side (˜>350), region B, the chopper is actively processing material, and in the central region of FIG. 1A ˜100-˜350), region C, is idling but without processing material. The motor pre pressure delta (green data points) is initially about zero in region A, and increases to about 2.500 pounds per square inch (psi) in region B during active processing, then subsequently drops to about 2.000 psi in region C as the chopper is operating but not processing material. The chopper is supplied with hydraulic fluid by a separate pump. In this example, the chopper's rotations per minute (RPM) is considered constant, therefore differential pressure is directly related to power supplied to the chopper.

Operation temperatures of machines vary throughout the day as various components of the machine warm and/or cool over time due to use as well as due to the influence of environmental factors such as ambient temperature, humidity, wind, etc. Temperature of the hydraulic fluid affects the viscosity of the fluid, which changes the resistance of that hydraulic fluid to flow. Colder hydraulic fluid has an increased oil viscosity, which subsequently causes the free-running power required for various components to increase. An example of the increase in hydraulic fluid temperature is shown in FIG. 1B, which is a graphical illustration of a difference in hydraulic fluid temperature over time of a hydraulic motor that is providing hydraulic power to a chopper of a sugarcane harvester. As can be seen in FIG. 1B, during operation of the chopper of the sugarcane harvester, the temperature of the hydraulic fluid increases, which affects the free-running pressure as can be seen in the “B” region of FIG. 1A.

Warmer hydraulic fluid has a decreased oil viscosity, which subsequently causes the free-running pressure and power required for various components to decrease relative to colder hydraulic fluid. This variability in free-running pressure and power leads to errors if the processing power of the component, for example the chopper, was used in an ensuing calculation, for example, for yield mapping.

One solution for this problem is to periodically operate the machine in its free-running state for a period of time and then monitor the pressure during that time. However, this solution is not a model one as it is not continuous, requires user intervention to cause the machine to operate in the free-running state, and creates a time inefficiency of requiring the machine to cease its operation. In the example of a sugarcane harvester chopper, the chopper will be running without throughput at the ends of a field the agricultural machine with the chopper is harvesting in, when the machine is turning around or when the machine stops in the field, which might normally only occur every 10-20 minutes.

### SUMMARY

In accordance with one or more embodiments, a method for determining a free-running pressure of a machine is provided. The machine can be any machine that includes a hydraulic circuit, such as an agricultural machine. The method includes receiving a measurement of a temperature of a hydraulic fluid within the hydraulic circuit of the machine. The hydraulic circuit of the machine includes a hydraulic pump configured to pump the hydraulic fluid through the hydraulic circuit. The method also includes determining the free-running pressure of the hydraulic motor based on the temperature of the hydraulic fluid.

An agricultural machine is also provided, which is one example of a machine that includes a hydraulic circuit. The agricultural machine includes the hydraulic circuit and a processor. The hydraulic circuit includes a hydraulic pump configured to pump a hydraulic fluid through the hydraulic circuit. The processor, which is operably connected to the hydraulic circuit is configured to receive a measurement of a temperature of a hydraulic fluid within a hydraulic circuit of the agricultural machine. The processor of the machine also determines a free-running pressure of the hydraulic motor based on the temperature of the hydraulic fluid.

Another agricultural machine is also provided, which is another example of a machine that includes a hydraulic circuit. The agricultural machine comprising: a chopper; a hydraulic circuit; an engine configured to produce power to drive the agricultural machine, a means for measuring a temperature of the hydraulic fluid; and a processor. The hydraulic circuit includes a hydraulic pump configured to pump a hydraulic fluid through the hydraulic circuit. The processor, which is operably connected to the hydraulic circuit is configured to receive a measurement of a temperature of a hydraulic fluid within a hydraulic circuit of the agricultural machine. The processor of the machine also determines a free-running pressure of the hydraulic motor based on the temperature of the hydraulic fluid.

These and other advantages of the disclosure will be apparent by reference to the disclosure herein and the accompanying drawings.

### BRIEF DESCRIPTION OF THE DRAWINGS

The patent or application file contains at least one drawing executed in color. Copies of this patent or patent application publication with color drawing(s) will be provided by the Office upon request and payment of the necessary fec.

FIG. 1A is a graphical illustration of a difference in pressure measured across a hydraulic motor that is providing hydraulic power to a chopper of a sugarcane harvester.

FIG. 1B is a graphical illustration of a difference in hydraulic fluid temperature over time of a hydraulic motor that is providing hydraulic power to a chopper of a sugarcane harvester.

FIG. 2 is an illustration of a machine, in this instance an agricultural machine, that includes a hydraulic circuit.

FIG. 3 is a flow chart of a method of the present disclosure.

FIGS. 4A and 4B are graphical illustrations of a measured hydraulic fluid temperature (Vertical Axis) at one point vs. Differential pressure (horizontal axis).

FIGS. 5A-5C are illustrations of data showing the difference in yield monitor mapping with and without adjusting for temperature (post-processed).

FIG. 6 is a table of values, including data of the yield monitor weight estimation percent error ((true weight-estimate weight)/true weight), processed according to the disclosed methods (top dashed line box) and not processed with the disclosed methods (bottom solid line box).

FIG. 7 shows a high level block diagram of a computer for implementing components of the present disclosure, according to an embodiment.

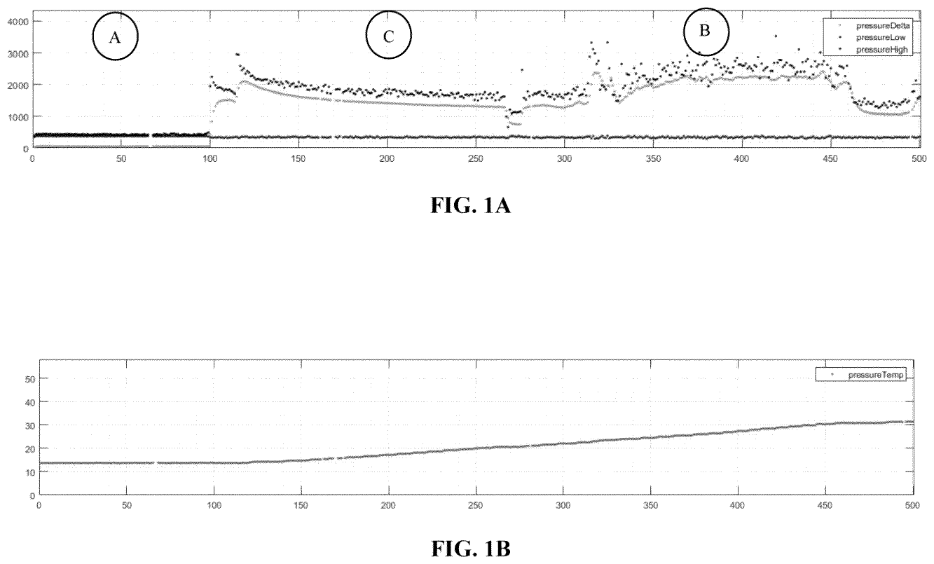

### DETAILED DESCRIPTION

Embodiments described herein provide for methods, and machines in conjunction with methods, for determining a free-running pressure of a machine. As used herein, the term “free-running pressure” and iterations thereof refer to an operating condition of a motor of a machine when that motor is operating at idle, which occurs when the motor is not under a load, e.g., neither processing a material nor causing the machine to move or operate but the motor is receiving power and rotating. “Free-running pressure” can be referred to as, e.g., “zero-throughput pressure” or “idle load”. To convert “free-running pressure” to a “free-running power” value, and vice versa, Equation 1 noted below can be used.

One embodiment of the present disclosure is directed to a method for determining a free-running pressure of a machine. The machine can be any machine that includes a hydraulic circuit, with that hydraulic circuit including a hydraulic pump configured to pump a hydraulic fluid within the hydraulic circuit.

As used herein, the term “hydraulic fluid” refers to any fluid suitable for use in a hydraulic circuit. Non-limiting examples of hydraulic fluids include water, oil, air, etc., and combinations thereof. In one non-limiting embodiment, hydraulic fluids may comprise ethers, butanol, silicones, aromatic hydrocarbons, esters, olefins, glycols, glycerine, saline, etc., and combinations thereof.

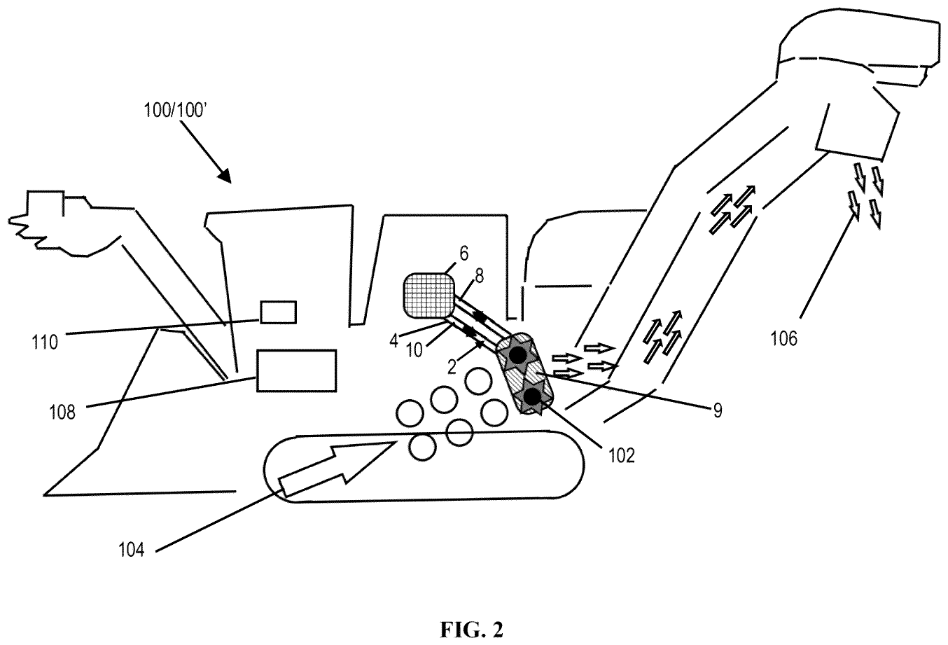

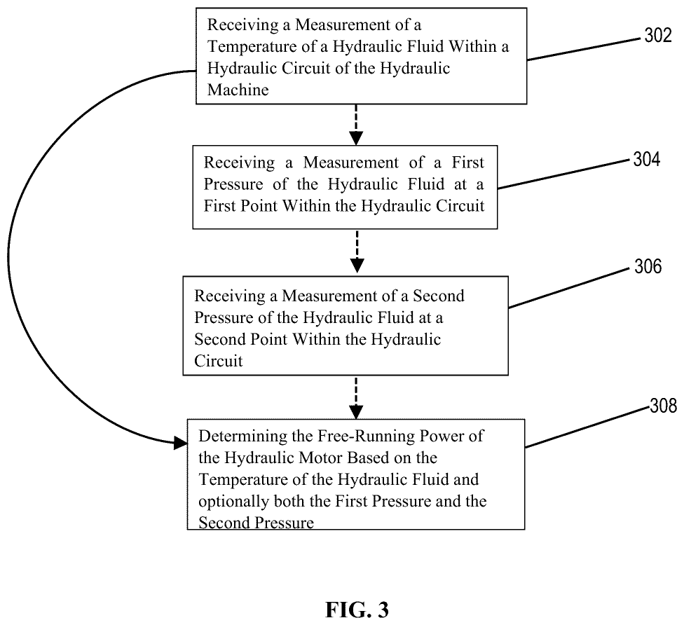

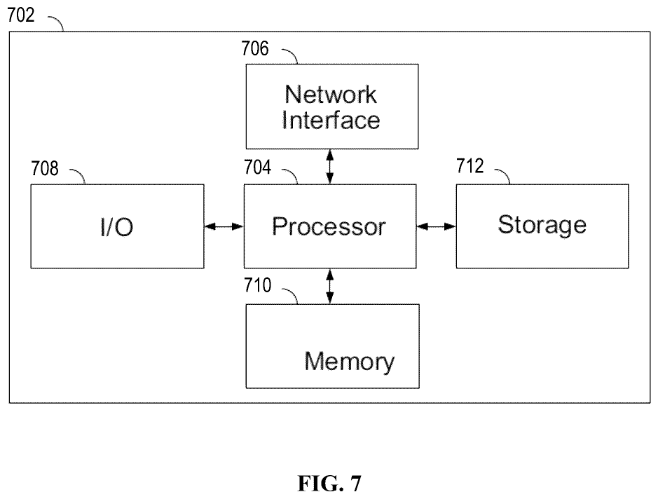

Determining the free-running pressure according to the present disclosure provides the advantage of real-time/run-time updates and therefore improves the accuracy of other measurements and determinations occurring with the machine. The method of this determination is illustrated in FIG. 3, with the method described in conjunction with an agricultural machine illustrated in FIG. 2. The method for determining free-running pressure includes step 302 of receiving a measurement of a temperature of a hydraulic fluid 2 within a hydraulic circuit 4 of the machine 100, the hydraulic circuit 4 comprising a hydraulic pump 6 configured to pump the hydraulic fluid 2 through the hydraulic circuit 4 to a hydraulic motor 9. The received temperature can be characterized as a signal, which can be received by any suitable processor, such as the processor illustrated in FIG. 7 and discussed herein.

The temperature received in the step 302 can be measured by any suitable temperature detector, such as a thermocouple, thermometer, infrared sensor, bimetallic device, resistive temperature measuring device, a change of state sensor and/or a silicon diode. Additionally, the temperature of the hydraulic fluid 2 can be measured at any suitable location within, or adjacent to, the hydraulic circuit 4, including within, or adjacent to, any component of the hydraulic motor 9.

As used herein the term “hydraulic circuit” and “hydraulic conduit” means any piping and/or hose elements configured to have hydraulic fluid within them. The hydraulic conduit may be composed of any suitable material, such as metals, plastics, rubbers, carbon based materials, etc. and combinations thereof.

Subsequently, the method for determining free-running pressure includes an optional step 304 of receiving a measurement of a first pressure of the hydraulic fluid 2 at a first point 8 within the hydraulic circuit 4. Alternatively to proceeding from step 302 to Step 304, the method can proceed directly from step 302 to step 308, discussed below. In embodiments where a particular agricultural machine's variable m and b, discussed below, are known, the method can include two steps, step 302 and step 308. In embodiments where a particular machine's variables m and b are not known within a predetermined accuracy threshold, the method can include four steps, step 302, then step 304, then step 306, then step 308.

In the embodiment including step 304, the first point 8 can be any point that is upstream of the hydraulic motor 9, within the hydraulic circuit 4. Arrows are included in the hydraulic circuit 4 of FIG. 2 to represent a direction of flow, however, these arrows are exemplary, and the direction of flow can be in the opposite direction.

Next, in this embodiment, the method for determining free-running pressure includes a step 306 of receiving a measurement of a second pressure of the hydraulic fluid 2 at a second point 10 within the hydraulic circuit 4. This can be any point that is downstream of the hydraulic motor 9, within the hydraulic circuit 4. The first pressure and the second pressure can be measured by any suitable pressure detector, such as a pressure sensor, a manometer, a pressure transducer, a gauge, an anemometer, etc., and combinations thereof. The locations of the first point 8 and the second point 10 are exemplary, in other embodiments their respective locations can be reversed or in different locations entirely. The received first pressure and the received second pressure can each be characterized as a signal, which can be received by any suitable processor, such as the processor illustrated in FIG. 7 and discussed herein.

In embodiments proceeding from step 302 to step 308, based on the temperature of the hydraulic fluid 2 within the hydraulic circuit 4, the free-running pressure of the hydraulic motor 9 can be determined in step 308. In embodiments including four steps, step 302, then step 304, then step 306, then step 308, based on the temperature of the hydraulic fluid 2 within the hydraulic circuit 4, the first pressure of the hydraulic fluid 2 at the first point 8 and the second pressure of the hydraulic fluid 2 at the second point 10, the free-running pressure of the hydraulic motor 9 can be determined in step 308.

In one embodiment, the free-running pressure determined is shown below using EQUATION 1:

$$Free Running Pressure = ( ( ( m * filteredPressureTemp ) + b ) )$$

In the above EQUATION 1, the free-running pressure is determined via a linear fit to the “filteredPressureTemp” variable. The “filteredPressureTemp” variable refers to the temperature of the hydraulic fluid 2 within the hydraulic circuit 4.

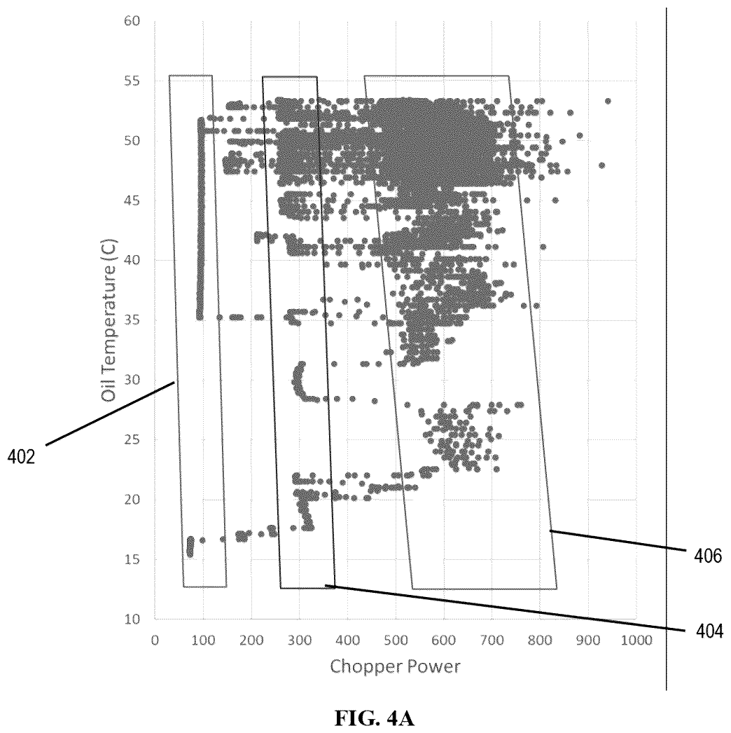

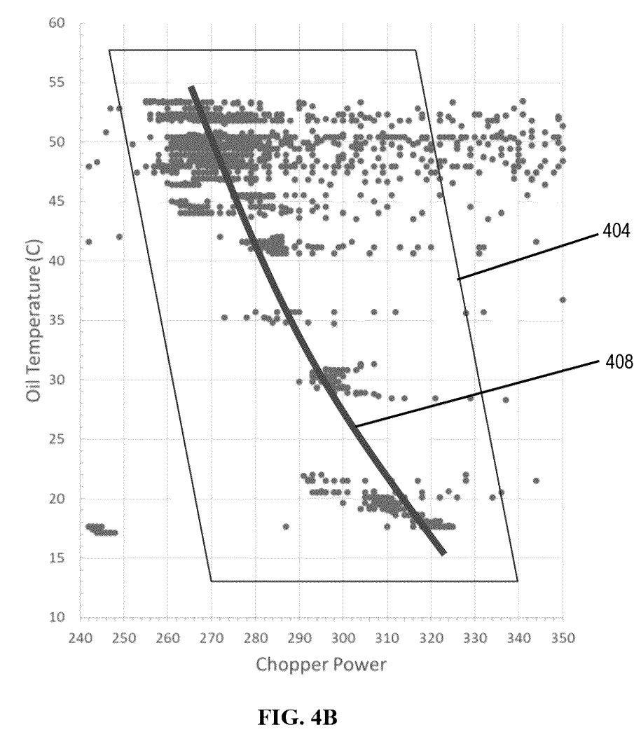

The m and b values of EQUATION 1 can be determined for a particular hydraulic circuit 4. For example, m can be assigned −2.7 and b can be assigned 317, which can be exemplary linear fit coefficients for a particular hydraulic circuit 4, which can be adjusted to more closely align with measured data (the relationship between pressure and temperature may be linear as shown in FIG. 4B (described below), and as noted in EQUATION 1, or non-linear (polynomial, etc.). Other linear fit coefficients can be predetermined and adjusted for a hydraulic circuit 4 and hydraulic motor 9 by measuring the difference between the first pressure of the hydraulic fluid 2 at the first point 8 and the second pressure of the hydraulic fluid 2 at the second point 10 across a range of hydraulic fluid 2 temperatures. From these measurements the linear fit coefficient for the particular hydraulic circuit 4 and hydraulic motor 9 can be determined.

The difference between the first pressure of the hydraulic fluid 2 at the first point 8 and the second pressure of the hydraulic fluid 2 at the second point 10 can be referred to herein as “total pressure”.

The Free Running Pressure of EQUATION 1 above can be converted to a “Free Running Power” value by multiplying the Free Running Pressure by “Motor RPM”. The “Motor RPM” is a measurable value of the rotations per minute of the hydraulic motor 9 at any time point. In some instances, the “Motor RPM” can be replaced with a measurement of flow of hydraulic fluid 2 through the hydraulic circuit 4.

When the machine 100 is an agricultural machine 100′, as it is in FIG. 2, pressure for various hydraulically driven components can be calculated. For example, a “cutting pressure” of a chopper component of the agricultural machine 100′, which is the pressure used to operate the chopper component during a chopping or harvesting process, can be determined by determining “total pressure” minus the free running pressure determined in EQUATION 1. That determined “cutting pressure” can be converted to a “cutting power” by multiplying the “cutting pressure” by rotations per minute (RPMs) of the chopper component, which is a measurable value of the rotations per minute of the chopper component at any time point. In some instances, the chopper component “RPM” can be replaced with a measurement of flow of hydraulic fluid 2 through the chopper component.

This “cutting power” is the amount of power used by the chopper component (or any other driven component) during operation, such as during a chopping or harvesting process, that can be attributed to the chopping or harvesting process itself and not to operation of the chopper component itself.

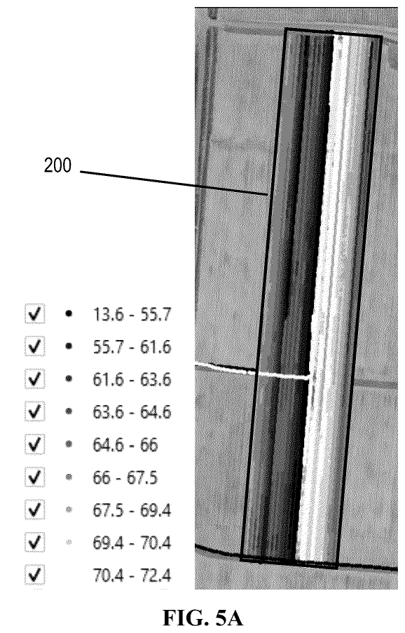

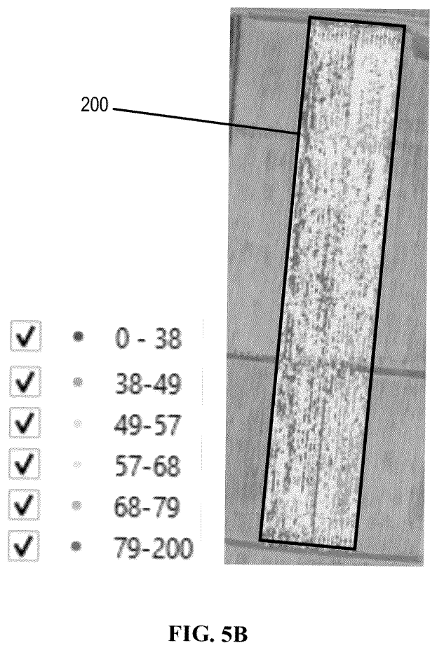

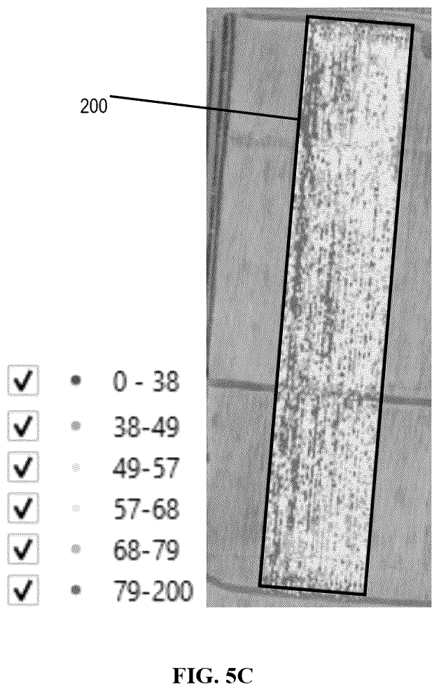

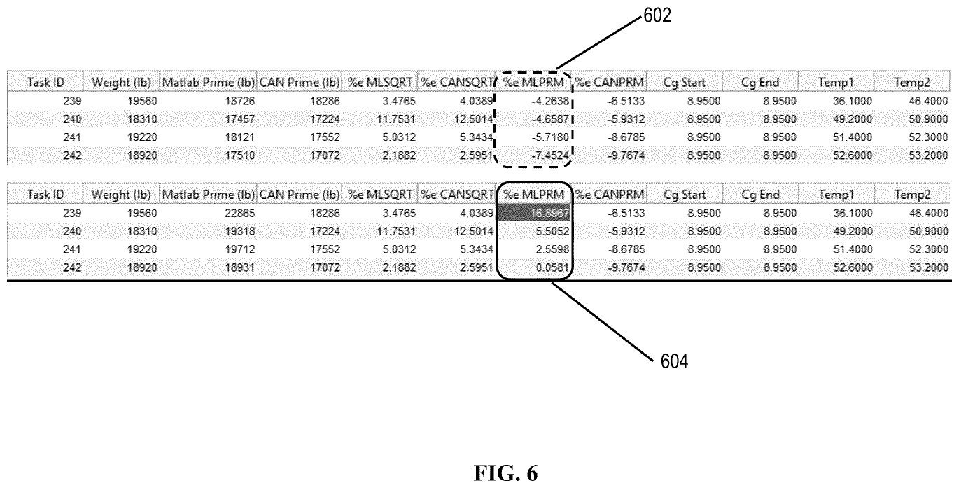

When the machine 100 is an agricultural machine 100′, as it is in FIG. 2, the free-running pressure can be determined during harvesting operations in an area, such area 200 of FIG. 5A (described below).

During harvesting operations, the speeds of various components, such as rotations per minute of a chopper component, can be used in conjunction with the determined free-running pressure to determine the power requirement of one or more components of the agricultural machine, such as the power requirement of the chopper for processing material.

The method of the present disclosure can further include receiving geotagged harvest yield data in the area 200, from the agricultural machine 100′ generated during the harvesting operations. The geotagged harvest yield data can be calculated according to the following EQUATION 2:

$$Harvest Yield = \frac{Mass throughput}{( Grou n d speed * Cutting width )}$$

The mass throughput of processed harvestable crop 106 can be estimated by scaling the cutting power measurements of the chopper 102 as they are gathered over time by a calibration factor that can be predetermined and/or refined for a particular type of agricultural machine 100′ and/or a particular type of chopper 102. The groundspeed is the speed at which the agricultural machine 100′ is moving during the harvesting operations of the area 200. The cutting width is the width of the mechanism of the agricultural machine 100′ performing the harvesting operation, such as the width of the reel of a combine harvester, and remains constant geographically and temporally. Each of the mass throughput and the groundspeed measurements can be linked temporally by a time tagging process and geographically by a geotagging process.

The geotagged harvest yield data includes data to describe the mass throughput of the harvested material at various locations within the area 200 as estimated by a power requirement of a component of the agricultural machine 100′, such as a chopper 102. The harvest yield data is associated with location data from a Global Navigation Satellite System (GNSS) of the agricultural machine 100′. Harvesting operations includes actively collecting any harvestable crop 104 through action(s) of the agricultural machine 100′.

The geotagged harvest yield data can then be temporally correlated with the determined “cutting power” during that harvesting operation in the area 200, to generate a yield map of the area 200, examples of which are shown in FIGS. 5A-5C, discussed further below. A yield map can be generated in any suitable way, and is a visual representation of yield values attained during a harvesting operation for a number of portions of the area 200. A yield value is a quantification of yield for a portion of the area 200, such as, for example, bushels harvested per acre (or some other land area such as a hectare or square foot), and/or dollars per acre (or some other land area such as a hectare or square foot).

As can be seen in FIG. 5A, visualized by the different colors, varying hydraulic fluid 2 temperature at different parts of the field typically occur due to agricultural machine 100′ warm up, operation of the agricultural machine 100′, etc. FIG. 5B is typical yield data of the area, without application of the disclosed method, while FIG. 5C is the same yield data of FIG. 5B, but with the application of the disclosed methods of estimating free running pressure based on temperature (of FIG. 5A) of hydraulic fluid 2. FIGS. 5A-5C are further described below in Example 2.

Methods of the present disclosure can also include, after reception of the geotagged harvest yield data in the area 200, as noted above, an estimate of a mass throughput of processed, harvestable crop 106. In this embodiment, the geotagged harvest yield data can then be temporally correlated with the cutting power during that harvesting operation in the area 200, to estimate a mass throughput of the processed, harvestable crop 106 of any portion of, or the entirety of, the area 200.

Methods of the present disclosure can also include measuring an actual free-running pressure of the hydraulic motor 9 using any suitable method, and then comparing that actually measured free-running pressure to the determined free-running pressure. If there is a difference above a certain first threshold, including a first threshold of 0%, the determined free-running pressure can be calibrated to be within a second, predetermined threshold of the actually measured free-running pressure. That second, predetermined threshold can be preset or modifiable as desired, and can be any suitable amount. One option for calibrating the determined free-running pressure can be automatically modifying one or both of the numerical values of EQUATION 1. For example, the “−2.7” value and/or the “+317” value can be modified one or more times until the determined free-running pressure is within the second, predetermined threshold of the actually measured free-running pressure.

The above discussion refers to methods of determining free-running pressure in a machine, the disclosure is also directed to methods of operating machines, including agricultural machines. Agricultural machines can include any machine used in conjunction with agricultural activities that includes a hydraulic circuit, non-limiting examples of which are a tractor, a cultivator, a tiller, a harvester, etc. In addition, the term agricultural machine may refer not only to implements configured to be towed or otherwise pulled across a field, but also to the agricultural vehicle (e.g., a tractor) configured to tow or pull such implement(s) across the field and/or the combination of a vehicle/implement. Thus, for example, an agricultural machine may correspond separately to an agricultural vehicle or implement or collectively to the combination of an agricultural vehicle/implement.

The agricultural machine, such as the agricultural machine 100′ of FIG. 2 can be operated according to the determined free-running pressure as discussed above in steps 302 to 304 to 306 to 308 and/or as discussed above in steps 302 followed directly by step 308.

Based on the determined free-running pressure, as noted above, the mass throughput can be estimated, and based on this mass throughput, a ground speed of the agricultural machine 100′ can be automatically changed. For example, if the mass throughput is above a threshold, the ground speed, and for example the harvesting speed, of the agricultural machine 100′ can be automatically decreased to a predetermined value and/or in step-wise manner. If free-running pressure is subsequently determined, this subsequent free-running pressure can also be used to further automatically change the ground speed of the agricultural machine 100′.

Based on the mass throughput, estimated as noted above, an energy consumption of the agricultural machine 100′ can be automatically changed. For example, if the estimated mass throughput is above a threshold, the energy consumption (e.g. fuel consumption, electricity consumption, combinations thereof, etc.) of the agricultural machine 100′ can be automatically decreased to a predetermined value and/or in step-wise manner. This automatic decrease in energy consumption can reduce consumption by the agricultural machine 100′, which can aid in the overall energy efficiency of the agricultural machine 100′ and reduce energy costs of operating the agricultural machine 100′. If free-running pressure is subsequently determined, this subsequent free-running pressure can also be used to further automatically change the energy consumption of the agricultural machine 100′.

The agricultural machine 100′ can include other components, such as chopper 102. Chopper 102 can be any suitable device that can break apart relatively large pieces of harvestable crop 106 into relatively smaller pieces. The chopper 102 can be within the hydraulic circuit 4, with the chopper 102 receiving power from the hydraulic fluid 2 pumped through the hydraulic circuit 4 by the hydraulic pump 6, to the hydraulic motor 9.

The agricultural machine 100′ can also include, e.g. an engine 108. Engine 108 can be any suitable fuel powered engine, such as a gasoline or diesel engine, any suitable electrically powered engine, such as an electromagnetic motor, and combinations thereof. The engine 108 is configured to produce power and drive the agricultural machine 100′ forward and/or reverse, so that the agricultural machine 100′ can perform harvesting operations.

The agricultural machine 100′ can also include a processor 110. Processor 110 includes component(s) noted in reference to FIG. 7 below, and can include a transceiver to transmit data and/or receive data from any remote processors. The processor 110 alone and/or in conjunction with any remote processor(s) can be configured to interact with the agricultural machine 100′ and perform the methods disclosed herein. For example, the processor 110 can automatically change the ground speed of the agricultural machine 100′ by controlling the power of the engine 108.

### EXAMPLES

The disclosure is further described by the following examples, which are not intended to limit the scope of the invention recited in the claims.

### Example 1

FIGS. 4A and 4B are graphical illustrations of a measured hydraulic fluid temperature (Vertical Axis) at one point vs. Differential pressure (horizontal axis). In these figures, the relationship between oil temperature and the free-running pressure requirements of a chopper motor are shown. In these figures the motor's rotations per minute (RPM) are considered constant, therefore pressure is directly related to the pressure differential upstream and downstream of the hydraulic motor 9, the difference between the first pressure of the hydraulic fluid 2 at the first point 8 and the second pressure of the hydraulic fluid 2 at the second point 10 of FIG. 2.

In FIG. 4A, the graph is plotted over a relatively wide pressure range of about 400-about 1200 psi to measure the pressure at varying points of use of the motor, which in this example is operating a chopper. Over the time frame of this in FIG. 4A, data collection in three distinct regions is visible; a) region 402; chopper off (blue), b) region 404; chopper running empty (red), and c) region 406; chopping/processing material (green).

As the determination of the free-running pressure is desired, the red box (region 404) of FIG. 4A is focused on as this data represents the pressure differential when the chopper is receiving power, but not processing any harvestable crop 104. FIG. 4B focuses on this data and is plotted over a relatively narrow range (about 500 psi-about 800 psi).

As temperature (vertical axis) increases a decreasing pressure trend is measured. In the view of FIG. 4B, the groups of points (acquired at different temperatures as the chopper of the harvester runs empty for a few moments) can be approximately fit to an equation as shown by the red line 408.

From the data measured in FIGS. 4A and 4B, including the red, curved line 408 of FIG. 4B, an equation to determine free-running pressure is made, such as EQUATION 1 above. Although this equation may be used to determine free-running pressure of any machine with a hydraulic circuit, these measurements can be made for any individual machine (including at various points in time) to create a modified version of EQUATION 1 that may differ from EQUATION 1. Modifications from EQUATION 1 can include different numerical values as compared to the ones shown, which would be calibrated for that individual machine at that point in time. Further, modifications from EQUATION 1 can include non-linear correlations between hydraulic fluid 2 temperature, such as polynomial correlations. Alternatively or in addition to modifications of EQUATION 1 noted above, the determination of free running pressure can be determined through a lookup table that correlates measured temperature(s) to an associated free running pressure.

As such, the relationship between oil temperature and free-running pressure may be learned in reference to EQUATION 1 through a calibration procedure and may also be updated if/when free-running pressure data is available.

### Example 2

FIGS. 5A-5C are aerial views of an area 200 of land that has been harvested. The aerial view of FIG. 5A is overlaid with hydraulic fluid temperature. Each of the aerial views of FIGS. 5B and 5C are overlaid with yield monitor mapping. FIGS. 5A-5C illustrates the changes in hydraulic oil temperature changes of a sugarcane harvester (one example of agricultural machine 100′) and the effect on yield estimations, where the chopper power is used to estimate the mass throughput of the sugarcane harvester.

FIG. 5A is a map of the hydraulic fluid temperature of the sugarcane harvester as it performed harvesting activities in area 200. FIG. 5B is a yield map of estimated mass throughput of harvested sugarcane based on chopper power, without any influence from a determined free-running pressure, which is what occurs now in the industry. FIG. 5C is a yield map of estimated throughput of harvested sugarcane based on chopper power and determined free-running pressure of the hydraulic motor 9, according to the present disclosure. As can be seen in FIG. 5C, as compared to FIG. 5B, a more accurate, continuous gradient is produced with compensation for determined free-running pressure, thus yield results are affected by determinations of free-running pressure.

The table of FIG. 6 illustrates the changes in hydraulic oil temperature changes of a sugarcane harvester, with and without a determination of free-running pressure compensation applied, in terms of mass estimation percent error (predicted mass vs. true mass harvested). The upper dashed box 602 is of data that includes compensation with the determined free-running pressure, the lower solid box 604 is of data that is not compensated with a determined free-running pressure.

As can be seen in the table of FIG. 6, the compensated results in dashed box 602 are more consistent compared to non-compensated results of solid box 604. As can also be seen in the table of FIG. 6, when the there is a relatively large change in temperature during the harvesting operation, the compensated results in dashed box 602 (−4.26%) are more accurate compared to non-compensated results of solid box 604 (+16.9%). Additionally, the compensated results in dashed box 602 are more consistent, and substantially avoid the inconsistency of data in solid box 604 as these data are impacted by the change in hydraulic fluid temperature over time.

Systems, apparatuses, and methods described herein may be implemented using digital circuitry, or using one or more computers using well-known computer processors, memory units, storage devices, computer software, and other components, as illustrated in FIG. 7 and discussed below. Typically, a computer includes a processor for executing instructions and one or more memories for storing instructions and data. A computer may also include, or be coupled to, one or more mass storage devices, such as one or more magnetic disks, internal hard disks and removable disks, magneto-optical disks, optical disks, etc.

Systems, apparatus, and methods described herein may be implemented using computers operating in a client-server relationship. Typically, in such a system, the client computers are located remotely from the server computer and interact via a network. The client-server relationship may be defined and controlled by computer programs running on the respective client and server computers.

Systems, apparatus, and methods described herein may be implemented within a network-based cloud computing system. In such a network-based cloud computing system, a server or another processor that is connected to a network communicates with one or more client computers via a network. A client computer may communicate with the server via a network browser application residing and operating on the client computer, for example. A client computer may store data on the server and access the data via the network. A client computer may transmit requests for data, or requests for online services, to the server via the network. The server may perform requested services and provide data to the client computer(s). The server may also transmit data adapted to cause a client computer to perform a specified function, e.g., to perform a calculation, to display specified data on a screen, etc. For example, the server may transmit a request adapted to cause a client computer to perform one or more of the steps of the methods and workflows described herein. Certain steps of the methods and workflows described herein may be performed by a server or by another processor in a network-based cloud-computing system. Certain steps of the methods and workflows described herein may be performed by a client computer in a network-based cloud computing system. The steps of the methods and workflows described herein may be performed by a server and/or by a client computer in a network-based cloud computing system, in any combination.

Systems, apparatus, and methods described herein may be implemented using a computer program product tangibly embodied in an information carrier, e.g., in a non-transitory machine-readable storage device, for execution by a programmable processor; and the method and workflow steps described herein may be implemented using one or more computer programs that are executable by such a processor. A computer program is a set of computer program instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

A high-level block diagram of such a computer is illustrated in FIG. 7. The computer of FIG. 7 can be wholly contained on the machine 100, remote from the machine 100, or partially remote and partially on the machine 100. Computer 702 contains a processor 704 which controls the overall operation of the computer 702 by executing computer program instructions which define such operation. The computer program instructions may be stored in a storage device 712, or other computer readable medium (e.g., magnetic disk, CD ROM, etc.), and loaded into memory 710 when execution of the computer program instructions is desired. Thus, the methods disclosed herein can be defined by the computer program instructions stored in the memory 710 and/or storage 712 and controlled by the processor 704 executing the computer program instructions.

Accordingly, by executing the computer program instructions, the processor 704 executes an algorithm disclosed herein. Processor 704 can be configured to execute computer program instructions for executing appropriate algorithms for controlling operation of the machine 100, and certain other data processing operations of the machine. Processor 704 can be configured to execute computer program instructions for executing appropriate algorithms for controlling operations of any or all components of the machine 100.

The computer 702 also includes one or more network interfaces 706 for communicating with other devices via a network. The computer 702 also includes input/output devices 708 that enable user interaction with the computer 702 (e.g., display, keyboard, mouse, speakers, buttons, etc.) One skilled in the art will recognize that an implementation of an actual computer could contain other components as well, and that FIG. 7 is a high level representation of some of the components of such a computer for illustrative purposes.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A method for determining a free-running pressure of a machine, the method comprising:
receiving a measurement of a temperature of a hydraulic fluid within a hydraulic circuit of the machine, the hydraulic circuit comprising a hydraulic motor configured to pump the hydraulic fluid through the hydraulic circuit; and
determining the free-running pressure of the hydraulic motor based on the temperature of the hydraulic fluid.

2. The method of claim 1, further comprising the steps of:
receiving a measurement of a first pressure of the hydraulic fluid at a first point within the hydraulic circuit;
receiving a measurement of a second pressure of the hydraulic fluid at a second point within the hydraulic circuit, wherein determining the free-running pressure of the hydraulic motor is further based on the first pressure and the second pressure.

3. The method of claim 2, wherein the first point is upstream of the hydraulic motor and wherein the second point is downstream of the hydraulic motor.

4. The method of claim 1, wherein the machine is an agricultural machine, the free-running pressure is determined during harvesting operations in an area, and a mass throughput of the agricultural machine is based on the determined free-running pressure.

5. The method of claim 4, further comprising:
receiving geotagged harvest yield data in the area, from the agricultural machine generated during the harvesting operations, wherein the geotagged harvest yield data is determined based on the mass throughput in the area and a speed of the agricultural machine in the area; and
processing the geotagged harvest yield data to generate a yield map of the area.

6. The method of claim 1, further comprising:
measuring an actual free-running pressure of the hydraulic motor;
comparing the determined free-running pressure to the actual free-running pressure; and
calibrating the determined free-running pressure to be within a predetermined threshold of the actual free-running pressure.

7. The method of claim 4, wherein the machine is an agricultural machine and a ground speed of the agricultural machine is automatically changed based on the mass throughput.

8. The method of claim 4, wherein the machine is an agricultural machine and an energy consumption of the agricultural machine is automatically changed based on the mass throughput.

9. An agricultural machine comprising:
a hydraulic circuit comprising a hydraulic motor configured to pump a hydraulic fluid through the hydraulic circuit;
a processor operably connected to the agricultural machine, the processor configured for:
receiving a measurement of a temperature of the hydraulic fluid;
and
determining a free-running pressure of the hydraulic motor based on the temperature of the hydraulic fluid.

10. The machine of claim 9, wherein the processor is further configured for:
receiving a measurement of a first pressure of the hydraulic fluid at a first point within the hydraulic circuit; and
receiving a measurement of a second pressure of the hydraulic fluid at a second point within the hydraulic circuit, wherein determining the free-running pressure r of the hydraulic motor is further based on the first pressure and the second pressure.

11. The machine of claim 9, wherein the free-running pressure is determined during harvesting operations in an area, a mass throughput of the agricultural machine is based on the determined free-running pressure, and wherein a ground speed of the agricultural machine is automatically changed based on the determined mass throughput.

12. The machine of claim 9, wherein the free-running pressure is determined during harvesting operations in an area, a mass throughput of the agricultural machine is based on the determined free-running pressure, and wherein an energy consumption of the agricultural machine is automatically changed based on the determined mass throughput.

13. The machine of claim 9, wherein the processor is further configured for receiving geotagged harvest yield data in an area, from the agricultural machine generated during harvesting operations, wherein the geotagged harvest yield data is determined based on a mass throughput in the area, the mass throughput based on the determined free-running pressure, and a speed of the agricultural machine in the area.

14. The machine of claim 13, wherein the processor is further configured for:
receiving geotagged harvest yield data in the area, from the agricultural machine generated during the harvesting operations, wherein the geotagged harvest yield data is determined based on the mass throughput in the area, the mass throughput based on the determined free-running pressure, and a speed of the agricultural machine in the area; and
processing the determined free-running pressure during harvesting operations and the geotagged harvest yield data to generate a yield map of the area.

15. An agricultural machine comprising:
a chopper;
a hydraulic circuit comprising a hydraulic motor configured to pump a hydraulic fluid through the hydraulic circuit between the hydraulic motor and the chopper;
an engine configured to produce power to drive the agricultural machine;
a temperature detector for measuring the temperature of the hydraulic fluid; and
a processor operably connected to the agricultural machine, the processor configured for:
receiving a measurement of the temperature of the hydraulic fluid;
and
determining a free-running pressure of the hydraulic motor based on the temperature of the hydraulic fluid.

16. The agricultural machine of claim 15, wherein the processor is further configured for:
receiving a measurement of a first pressure of the hydraulic fluid at a first point within the hydraulic circuit; and
receiving a measurement of a second pressure of the hydraulic fluid at a second point within the hydraulic circuit, wherein determining the free-running pressure of the hydraulic motor is further based on the first pressure and the second pressure.

17. The agricultural machine of claim 15, wherein the free-running pressure is determined during harvesting operations in an area, a mass throughput of the agricultural machine is based on the determined free-running pressure, and wherein a ground speed of the agricultural machine is automatically changed based on the determined mass throughput.

18. The agricultural machine of claim 15, wherein the free-running pressure is determined during harvesting operations in an area, a mass throughput of the agricultural machine is based on the determined free-running pressure, and wherein an energy consumption of the agricultural machine is automatically changed based on the determined mass throughput.

19. The agricultural machine of claim 15, wherein the processor is further configured for: receiving geotagged harvest yield data in an area, from the agricultural machine generated during harvesting operations, wherein the geotagged harvest yield data is determined based on a mass throughput in the area, the mass throughput based on the determined free-running pressure, and a speed of the agricultural machine in the area; and processing the determined free-running pressure during harvesting operations and the geotagged harvest yield data to generate a yield map of the area.

20. The agricultural machine of claim 15, further comprising:
measuring an actual free-running pressure of the hydraulic motor;
comparing the determined free-running pressure to the actual free-running pressure; and
calibrating the determined free-running pressure to be within a predetermined threshold of the actual free-running pressure.
